(19) United States
(12) Patent Application Publication
(10) Pub. No.: US 2007/0277673 A1
(43) Pub. Date: Dec. 6, 2007

(54) Sweep control for membrane dryers

(76) Inventors: Robert O. Crowder, Lino Lakes, MN (US); John H. Burban, Lake Elmo, MN (US)

Correspondence Address: Thomas N. Phung;Jacobson and Johnson, Suite 285, One West Water Street, St. Paul, MN, 55107-2080, US

(21) Appl. No.: 11/810,600

(22) Filed: Jun. 6, 2007

Related U.S. Application Data
(60) Provisional application No. 60/811,332, filed on Jun. 6, 2006.

(51) Int. Cl. B01D 53/22

(52) U.S. Cl. 95/52; 96/10

(57) ABSTRACT

A system for supplying a compressed fluid with a reduced moisture content comprising a membrane dryer for receiving a compressed fluid and removing moisture therefrom, a compressed fluid source located upstream of the membrane dryer, a check valve located upstream of the membrane dryer to prevent backflow therethrough, an accumulator for receiving the compressed fluid discharged from the membrane dryer and an inlet on the membrane dryer for receiving a portion of a compressed fluid from the compressed fluid source wherein the portion of the compressed fluid is diverted from a compressed fluid located upstream of the membrane dryer.

### CROSS REFERENCE TO RELATED APPLICATIONS

This application claims priority to currently pending U.S. Provisional Application Ser. No. 60/811,332; filed on Jun. 6, 2006; titled METHOD OF SWEEP CONTROL FOR MEMBRANE DRYERS IN PRESSURE CYCLING SYSTEMS.

### STATEMENT REGARDING FEDERALLY SPONSORED RESEARCH OR DEVELOPMENT

None

### REFERENCE TO A MICROFICHE APPENDIX

None

### FIELD OF THE INVENTION

The present invention relates generally to the use of an apparatus and process for the removal of water vapor from gas streams, and more specifically to an optimized compressed gas system and method of operating the same utilizing a membrane gas dryer for systems, in which the gas pressure cycles, with minimal loss of function or efficiency, and with minimal membrane stress.

### BACKGROUND OF THE INVENTION

Compressed gas systems generally comprises of the following components: a power source, compressor, heat exchanger, particulate filter, aerosol coalescer, gas-drier, accumulator, pressure regulator(s), check valves, and the equipment in which the gas, such as air, nitrogen, natural gas, etc., is used.

In many compressed gas systems, the compressed gas consumption is less than the capacity of the compressor. There are several methods known in the industry to deal with these “excess” compressed gas situations. One common procedure is to run the compressor and store the compressed gas in an accumulator at high pressure, and then to shut off the motor and relieve the pressure in the compressor (commonly referred to as unloading). A check valve can be placed at the inlet to the accumulator to prevent the stored compressed gas from discharging back through the compressor. The motor remains off until the gas pressure in the accumulator drops to a pre-set level, at which point the motor restarts and the compressor then refills the accumulator.

Membrane devices such as membrane dryers are sometimes used in compressed gas systems to remove water vapor from the gas stream. Membrane dryers need a dry gas sweep or purge with which to remove the water vapor that permeates across the membrane. In many membrane dryer systems the dry gas sweep or gas purge is provided by decompressing a portion of the compressed gas. After this sweep is used to remove the water vapor that has permeated across the membrane dryer, it is generally vented and lost.

To date membrane dryers use a portion of the product gas (at the membrane outlet) for sweep purposes, since it has already been dried by the membrane dryer, and thus, after expansion and further associated drying, makes an ideal source of dry sweep gas. Since expansion causes drying of the compressed gas, we found that it would be possible to operate a membrane dryer in some cases by using the expanded feed gas as sweep. This has not been considered in the past since those skilled in the art believe that the resulting sweep will not be as dry, thus the performance of the membrane dryer will suffer because the membrane dryer will not be capable of drying the compressed gas any further than the dew point of the expanded feed gas.

### BRIEF SUMMARY OF THE INVENTION

The present invention provides a method for arranging a membrane dryer system. The compressed fluid system comprises a compressed fluid source providing an original compressed fluid stream, a membrane dryer for removing water vapor from a primary compressed fluid stream of the original compressed fluid stream flowing therethrough, and an accumulator connected to the membrane dryer for receiving the primary compressed fluid stream.

The membrane dryer includes a first fluid stream pathway, a second fluid stream pathway, and a selective membrane located therebetween. The first fluid stream pathway extends from a first inlet to a first outlet of the membrane dryer for directing the primary compressed fluid stream therethrough to remove water vapor from the primary compressed fluid stream. The second fluid stream pathway extends from a second inlet to a second outlet of the membrane dryer for directing sweep fluid stream of the original compressed fluid stream, which is at a reduced pressure compared to the original compressed fluid stream, therethrough to remove water vapor from membrane dryer.

The compressed fluid system also includes a one-way check valve located between the compressed fluid source and the membrane dryer with the one-way check valve allowing the primary compressed fluid stream to move therethrough into the membrane dryer while preventing fluids located in the membrane dryer from escaping therethrough. Located between the compressed fluid source and the one-way check valve is a tee for diverting the sweep fluid stream from the original compressed fluid stream to the second fluid stream pathway of the membrane dryer. The compressed fluid system also includes a flow control valve located between the tee and the membrane dryer for decompressing the sweep fluid stream before the sweep fluid stream enters the membrane dryer for sweep purposes.

### BRIEF DESCRIPTION OF THE DRAWINGS

FIG. 1 shows a diagram of one embodiment of the prior art with a compressed fluid membrane dryer system wherein a one-way check valve is placed before both a membrane dryer and an accumulator;

FIG. 1A shows an illustration of the operation of a membrane dryer;

FIG. 2 shows a diagram of a second embodiment of the prior art with a compressed fluid membrane dryer system wherein the one-way check valve is placed after the membrane dryer but before the accumulator; and

FIG. 3 shows a diagram of the current invention with a compressed fluid membrane dryer system wherein the one-way check valve is placed within the membrane dryer system and before the accumulator.

### DESCRIPTION OF THE PREFERRED EMBODIMENT

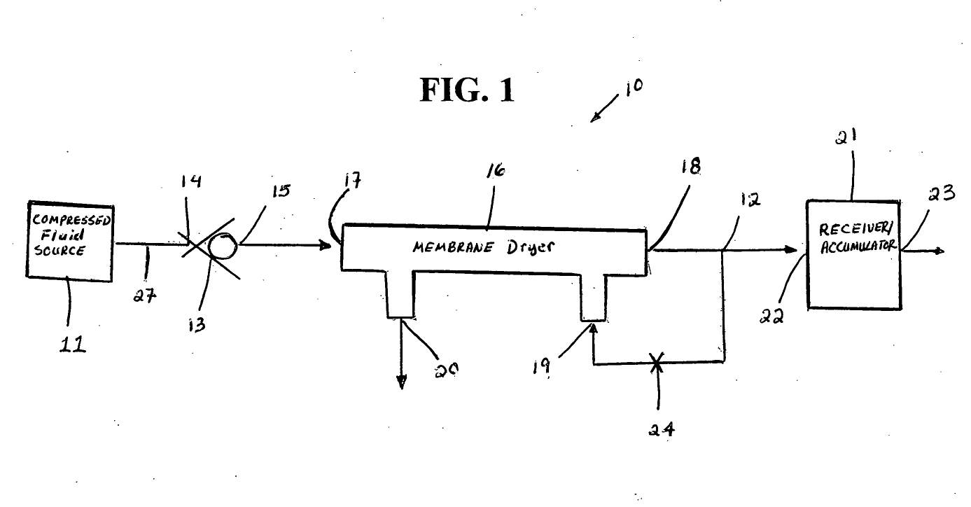

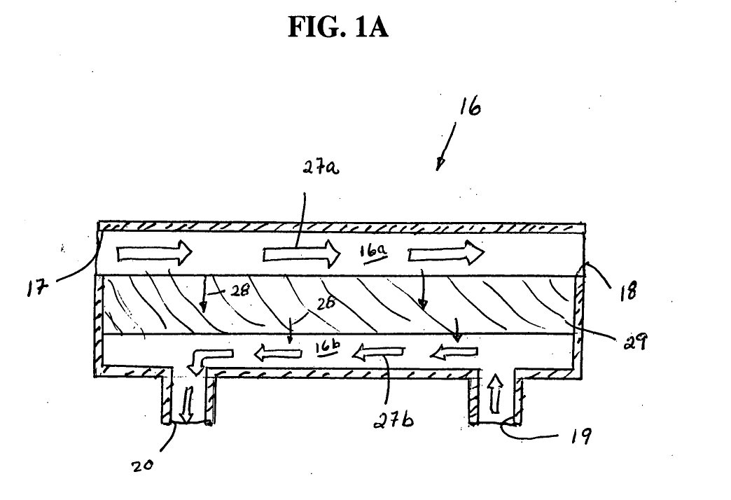

Referring to FIG. 1, FIG. 1 is a diagram showing a configuration of a compressed fluid membrane dryer system 10 comprising a source of compressed fluid 11, a membrane dryer 16 for receiving a compressed fluid, such as a compressed fluid stream and removing water vapor from the compressed fluid stream, and an accumulator 21 for receiving the compressed fluid stream discharged from the membrane dryer 16. It is noted that compressed fluid is generally defined as a fluid that is above atmospheric pressure. As such, a compressed fluid source can be any type of source which provides for a fluid that is above atmospheric pressure. Source of compressed fluid 11 in the present invention functions to provide for an original compressed fluid stream 27 generally comprising a clean gas with the aerosols of both water and oil removed therefrom.

Membrane dryer 16 is shown in FIG. 1 connected to the source of compressed fluid 11 via a first inlet 17 of membrane dryer 16 and functions to remove water vapor from an original compressed fluid stream 27 flowing therethrough from the source of compressed fluid 11.

FIG. 1A shows an illustration of the operation of membrane dryer 16. In general regards to membrane dryer 16, membrane dryer 16 may comprise a flat sheet membrane dryer, a hollow fiber membrane dryer, a spiral wound membrane dryer, or any other configuration of membrane in which two fluid streams are separated by a selective membrane. Membrane dryer 16 of FIG. 1A includes a flow passage comprising a first fluid stream pathway 16a extending from the first inlet 17 to a first outlet 18 of the membrane dryer 16 for directing a first fluid stream 27a therethrough. The first fluid stream pathway 16a is separated by a selective membrane 29 from a flow passage comprising a second fluid stream pathway 16b extending from a second inlet 19 to a second outlet 20 of membrane dryer 16 for directing a second fluid stream comprising a sweep fluid stream 27b therethrough. It is noted that the second fluid stream or sweep fluid stream 27b is at reduced pressure compared to first fluid stream 27a.

Accumulator 21 is shown connected to the first outlet 18 of membrane dryer 16 and functions to receive the primary compressed fluid stream 27a therein after the primary fluid stream has been dried by membrane dryer 16.

Compressed fluid membrane dryer system 10 of FIG. 1 includes a one-way check valve 13 located between and in fluid communication with both the source of compressed fluid 11 and the membrane dryer 16. The one-way check valve 13 is designed to allow fluid to flow from an inlet 14 to an outlet 15 of one-way check valve 13 but not in the reverse direction. That is, in the configuration of the compressed fluid membrane dryer system 10 of FIG. 1, one-way check valve 13 functions to allow the original compress fluid stream 27 to move through one-way check valve 13 in a direction from the inlet 14 to outlet 15 of one-way check valve 13 but not in the reverse.

Compressed fluid membrane dryer system 10 also includes a tee 12 located between membrane dryer 16 and accumulator 21. In membrane dryer system 10, tee 12 is connected to the first outlet 18 and second inlet 19 of membrane dryer 16 and a first inlet of accumulator 21 and in fluid communication with the first outlet 18 of membrane dryer 16 and a first inlet of accumulator 21. Tee 12 functions to divert the sweep fluid stream 27b of the original compressed fluid stream 27 through the second fluid pathway 16b of membrane dryer 16 via the second inlet 19 and the second outlet of membrane dryer 16 to remove water vapor from membrane dryer 16.

Located between tee 12 and the second inlet 19 of membrane dryer 16 is a flow control valve 24 for decompressing or expansion of the gas in the compressed sweep fluid stream 27b to further dry the sweep fluid stream 27b before the sweep fluid stream 27b enters the second inlet 19 of membrane dryer 16.

Although it is noted that it would be possible in some situations to operate membrane dryer 16 by using the aforementioned expanded feed gas as a sweep, this has not been considered in the past since the resulting sweep will not be as dry, thus the performance of the membrane dryer 16 in drying the compressed fluid stream 27 flowing through membrane dryer 16 via the first inlet 17 and the first outlet 18 of membrane dryer 16 will suffer, and the membrane dryer 16 will not be capable of drying the compressed fluid stream 27 any further than the dew point of the expanded feed gas.

In further regards to flow control valve 24, in most compressed fluid system that uses membrane dryer device, the flow control valve 24 comprises either a fixed orifice or a controlled leakage through the membrane dryer 16. The aforementioned leakage flow is then controlled by the membrane unit pressure, which leads to membrane dryer 16 generally using gas continuously as sweep whether there is any net gas demand on the dryer or not. This presents a problem for systems in which the source of compressed fluid 11, such as a compressor, is shut off once demand has been met and the accumulator 21 filled. If membrane dryer 16 is installed after the one-way check valve 13 but before the accumulator 21, as shown in FIG. 1, membrane dryer 16 will consume gas continuously, whether it is being used to dry gas produced by source of compressed fluid 11. This increased gas consumption provides no benefit, and causes the source of compressed fluid 11 to come back on sooner, since the accumulator 21 will be drained faster.

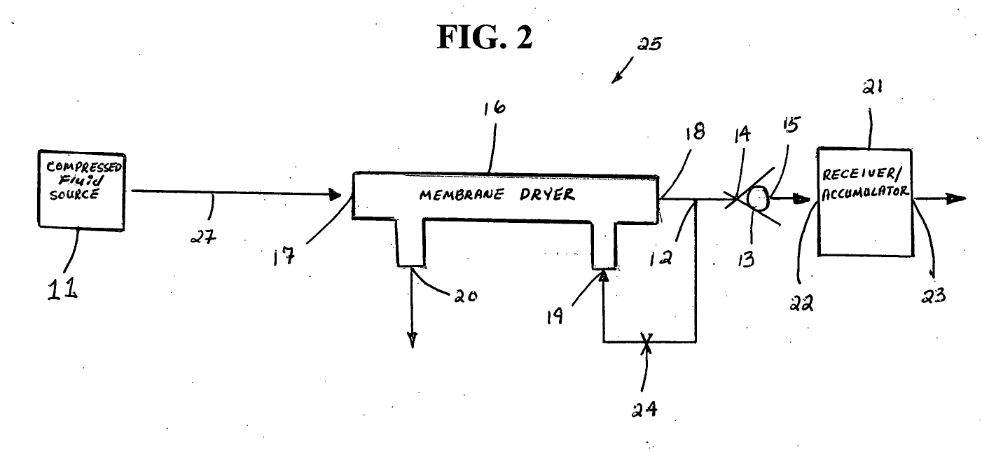

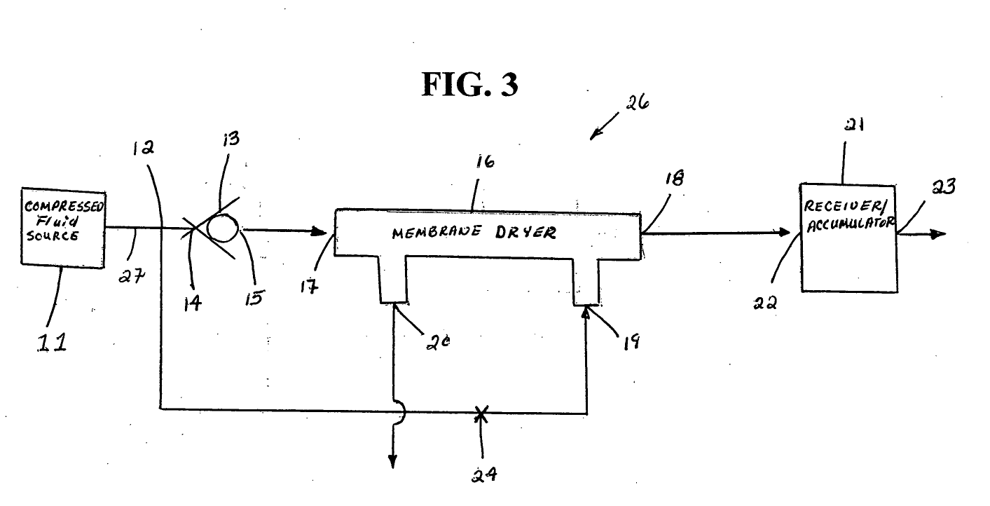

Referring generally to FIGS. 2 and 3, for the clarity purposes, it should be noted that for FIGS. 2 and 3, identical components having identical functions as the components for the compressed fluid membrane dryer system 10 of FIG. 1 of the drawings have been marked with the same reference numerals for FIGS. 2 and 3.

FIG. 2 shows a configuration of a compressed fluid membrane dryer system 25, which addresses the above problem of the compressed fluid membrane dryer system 10 of FIG. 1 by installing the membrane dryer 16 prior to the one-way check valve 13 and the accumulator 21. Thus when the source of compressed fluid 11 stops or is turned off and the compressed fluid membrane dryer system 25 unloads, the membrane dryer 16 stops using gas. The sweep via the sweep fluid stream 27b moving through membrane dryer 16 does not resume until the accumulator 21 drains due to system demands and the source of compressed fluid 11 starts up again to refill the accumulator 21.

Although compressed fluid membrane dryer system 25 solves the gas conservation issue, there are two problems associated with compressed fluid membrane dryer system 25. Firstly, as the source of compressed fluid 11 first starts and begins pressurizing the membrane dryer system 25 prior to the one-way check valve 13, gas starts passing through the membrane dryer 16 while at very low pressure and consequently with very little sweep and often at much higher flow rates. This means that the initial fluid flowing through the membrane dryer 16 is not dried as well and as the fluid is subsequently compressed downstream prior to the one-way check valve 13, the fluid could produce condensation and a slug of water.

Secondly, the gas pressure in the membrane dryer 16 cycles as the source of compressed fluid 11 cycles. This can cause wear and fatigue of the membrane dryer 16. Since the total volume of the membrane dryer system 25 prior to the one-way check valve 13 is generally small compared to the output of the source of compressed fluid 11, the rate of pressurization can be quite high. This high rate of pressurization can fatigue the polymeric materials from which the membrane dryer 16 is commonly constructed. One way to deal with the two complications presented by the compressed fluid membrane dryer system 25 of FIG. 2 is to change the configuration of compressed fluid membrane dryer system 25 back to the configuration of the compressed fluid membrane dryer system 10 shown in FIG. 1 and replace valve 14, which usually comprises a fixed orifice, with a controllable valve.

This control can be done pneumatically, using gas pressure from the source of compressed fluid 11, for instance, to open a solenoid valve. Alternatively, the control can be done electronically, with an electric signal from the source of compressed fluid 11 or a control circuitry. The control can also be done mechanically, using the gas flow through the module, for instance, to control the amount of sweep flow. In this way the membrane dryer 16 is always kept at pressure thereby saving membrane fatigue, and the compressed fluid system only consumes gas as purge when there is a demand on the source of compressed fluid 11 and there is a net product flow.

While using solenoid valves or some sort of control circuit to adjust the purge flow solves the problems outlined, one of the disadvantages of their use is that it can be fairly costly, especially for smaller systems. In addition these moving pieces of equipment are also susceptible to fatigue and failure in their own rights.

The present invention provides a compressed fluid membrane dryer system 26 that corrects the problems outlined in the compressed fluid membrane dryer systems 10 and 25 of FIGS. 1 and 2 while reducing the cost and problems associated with the use of solenoid valves or control circuit that adjusts the purge flow of the membrane dryers. An embodiment of the present invention is shown in FIG. 3. With the configuration shown in FIG. 3, by having the one-way check valve 13 located upstream of the membrane dryer 16, the membrane dryer 16 is kept at the receiver/accumulator pressure as long as the receiver/accumulator 21 is at pressure. When the compressed gas source 11, which typically comprises a compressor as the sole source of the compressed gas, shuts off, the one-way check valve 13 located prior to the membrane dryer 16 keeps the membrane dryer 16 from decompressing. Thus the device 16 does not undergo pressure cycling, only the variations that the accumulator 21 undergoes, which are generally mild. Also when the compressed gas source 11 starts up, the membrane dryer 16 does not undergo the rapid pressurization that the compressed fluid membrane dryer system 26 undergoes prior to the check valve 13.

With the configuration of the compressed fluid membrane dryer system 26 of FIG. 3 since tee 12, which is located upstream of both membrane dryer 16 and check valve 13, supplies the sweep gas 27b to membrane dryer 16 prior to the one-way check valve 13, membrane dryer 16 uses sweep gas 27b only when the membrane dryer system 26 is pressurized prior to the one-way check valve 13. Thus the membrane dryer 16 uses sweep when the compressed gas source 11 is running and the membrane dryer system 26 is filling the accumulator 21. Once the accumulator 21 is full, the membrane dryer system 26 stops, unloads and thus the sweep gas 27b shuts off. Under compressed fluid membrane dryer system 26, there is no gas use when the membrane dryer 16 does not have a fluid stream flow through membrane dryer 16, and the accumulator 21 is supplying the required gas.

Lastly, since the membrane dryer 16 is constantly at pressure, there is no point at which fluid flows through the membrane dryer 16 without being dried. Purge gas begins flowing as soon as the compressed gas source 11 starts, and will reach full flow when the compressed fluid membrane dryer system 26 reaches the pressure of the accumulator prior to the one-way check valve 13 and the one-way check valve 13 opens allowing gas to begin flowing through the membrane dryer 16. This avoids the possibility of a slug of water being created during start up of the compressed gas source 11 as in the membrane dryer system 25 described in FIG. 2.

In further regards to the compressed fluid membrane dryer system 26 of FIG. 3, note that the drawing shows a counter-current flow configuration, but the device can also operate with other types of current configuration such as but not limited to a co-current configuration and a cross-current configuration. In general a counter-current flow configuration is preferable for best membrane performance, but the present invention will work with any flow configuration.

Referring back to FIG. 1A, in the operation of membrane dryer 16, as the high-pressure primary compress fluid stream 27a flows from the first inlet 17 to the first outlet 18 of the membrane dryer 16, the selective membrane 29 functions allows water vapor 28 to permeate across and enter the sweep fluid stream 27b flowing from the second inlet 19 to the second outlet 20 of the membrane dryer 16. The high-pressure primary compress fluid stream 27a will have less water vapor by the time it reaches the first outlet 18 of membrane dryer 16 than it did when it entered at the first inlet 17 of membrane dryer 16. Water vapor will only permeate across the membrane dryer 16 to the sweep fluid stream 27b if there is a chemical potential driving force for the mass transfer. This chemical potential driving force is commonly assumed to be the difference in water vapor activity from one stream to the other. For water vapor at the pressures generally of interest, it is common to substitute for the activity the ratio of water vapor pressure to the saturated vapor pressure. Then the activity simply becomes the fraction of saturation, or if expressed as a percentage, the relative humidity (hereinafter RH). Water vapor will permeate across the membrane 29 from the stream with the higher relative humidity to the stream with the lower relative humidity, and if they are equal, there will be no driving force for permeability at all.

For instance, for a system operating at 100 psig using a portion the feed gas or original compressed fluid stream 27 as sweep, the system would be unable to reduce the humidity of the high pressure gas below 12.8% of the inlet humidity (usually 100%), since this is the reduction in humidity that would result from expanding a portion of the feed gas from 100 psig to 0 psig. Thus if the inlet gas were saturated at 100° F., the membrane dryer would not be able to reduce the gas dew point below about 40° F. (RH=12.8%) no matter how high a sweep fraction is used. Consequently the maximum dew point suppression for such a system would be about 60° F., where achieving anything close to that would require a very high sweep ratio and a very large amount of membrane. Many compressed gas systems, however, only need moderate dew point suppression, of 20° F. or so, where we have found that using the feed gas as the source of sweep provides acceptable performance.

By comparison a system as shown in FIG. 1 or FIG. 2, using a portion of the product gas as sweep to dry the feed gas by 20° F. dew point, would only operate slightly better, if at all at this modest dew point suppression of 20° F. Here the outlet gas would have a dew point of 80° F., which would be about 53.4% RH. In this case the sweep gas, once decompressed and supplied to the second inlet 19, would have 12.8% of the product compressed air humidity at the first outlet 18, which would be about 6.8% of the inlet humidity or 6.8% RH. While a membrane operating with a sweep of 6.8% RH may seem much better than one operating at 12.8% RH, the driving force for water vapor permeation is based on the difference in water vapor activity from the high pressure side to the low pressure side, thus the difference at the first outlet 18 of membrane dryer 16 is 0.466 (0.534-0.068) for a system operating as in FIG. 1 or 2 as opposed to 0.406 (0.534-0.128) for a system operating as in FIG. 3. Thus the driving force at this portion of the membrane would be about 15% higher for a membrane dryer 16 operating as in FIG. 1 or 2 as open as opposed to one operating as in FIG. 3. For such systems the loss in driving force for water vapor permeation is not significant, especially since the residence time of the gas in the system shown in FIG. 3 would be greater and the ratio of sweep gas to high-pressure gas is higher.

We conducted experiments to determine the difference in drying performance of a membrane dryer 16 when operated under steady state conditions (compressed gas source 11 continuously on, a constant system pressure, and a constant system demand at 23). Under these conditions, the check valve 13 is continuously open, and FIGS. 1 and 2 become equivalent. We thus operated the five membrane dryers 16 using the product air for sweep, as shown in FIGS. 1 and 2. We then operated the same five membrane dryers 16 using the feed air as sweep, as shown in FIG. 3. We operated all five membrane dryers 16 with 2.0 SCFM of air flow leaving the system at 23 and with 0.2 SCFM of air flow leaving the system at 20. In all cases the system pressure was 100 psig. The dew point for these experiments measured at the first inlet 17 ranged from 33° F. to 47° F. The dew point suppression (dew point measured at first inlet 17 minus dew point measured at first outlet 18) was calculated for each module in each of the two effective configurations. The average dew point suppression for the five membrane dryers 16 in the configuration equivalent to FIGS. 1 and 2 was 21.5° F. with a standard deviation of 0.7° F. The average dew point suppression for the five membrane dryers 16 in the configuration equivalent to FIG. 3 was 20.3° F. with a standard deviation of 0.7° F. Thus the dew point suppression for these membrane dryers 16 operated in the two different configurations at this relatively low dew point suppression is fairly similar.

For membrane dryers, the difference in RH between the two streams 27a and 27b in FIG. 1A is generally generated by decompressing the sweep stream to generate a compressed fluid stream at a reduced pressure compared to the high-pressure primary compress fluid stream 27a. Assuming ideal gas and isothermal conditions, the RH after decompression is equal to the RH prior to decompression multiplied by the ratio of outlet absolute pressure over the inlet absolute pressure. This decompression happens across valve 24, which is in fluid communication with the tee 12 and the second inlet 19 of membrane dryer 16. Valve 24 can comprise of any sort of control valve regulating flow. One of the most common examples of valve 24 is a fixed orifice. This expansion both reduces the RH of the sweep stream and increases the volumetric flow of sweep entering the membrane dryer 16 at second inlet 19, which then allows the sweep stream to remove water vapor from the compressed gas stream before the sweep exits at the second outlet 20 of membrane dryer 16.

Note that when the compressed gas source 11 shuts off in a system arranged according to FIG. 3, and the pressure at the compressed gas source 11 drops to ambient. Flow through the check valve 13 will stop, but the check valve 13 will keep the high-pressure side of the membrane dryer 16 at high pressure. The flow through the valve 24 will also stop, since the pressure above the valve 24 at tee 12 and below the valve 24 at the second inlet 19 of membrane dryer 16 will both be approximately ambient.

The membrane dryer 16 will thus stop consuming gas as sweep until the compressed gas source 11 restarts, and the pressure at compressed gas source 11 increases again. At this point flow will resume through the valve 24, creating a sweep flow through the membrane dryer 16 from the second inlet 19 to the second outlet 20 of the membrane dryer 16. Once the pressure at compressed gas source 11, which is in communication with the inlet 14 of one-way check valve 13, surpasses the pressure at the outlet 15 of one-way check valve 13, flow will once again resume through one-way check valve 13 and consequently through the primary compressed fluid stream 27a from the first inlet 17 to the first outlet 18 of the membrane dryer 16 supplying the system connected to an outlet 23 of the accumulator 21 and recharging the accumulator 21 with any excess. The primary compressed fluid stream 27a, which has had the water vapor reduced by the membrane dryer 16 exits at the first outlet 18 of membrane dryer 16, which is in fluid communication with an inlet 22 of the receiver/accumulator 21. The outlet 23 of receiver/accumulator 21 then supplies the dried primary compressed fluid stream 27a to the desired system.

With the present system the pressure on the high pressure side of the membrane dryer 16, from the first inlet 17 to the first outlet 18 of membrane dryer 16, is not allowed to decompress, so the membrane is not subjected to as much stress as systems in which the high pressure side is allowed to decompress. With the present system, the sweep flow from second inlet 19 to the second outlet 20 of membrane dryer 16 is shut off when the compressed gas source 11 shuts off. This minimizes gas waste. Finally, since the pressure supplied to valve 24 shuts off when the compressed gas source 11 shuts off, a simple flow control can be used for valve 24, reducing cost over a complicated flow control valve system.

In further regards to membrane dryer system 26, it is noted that one of the limitations of membrane dryer system 26 is that the use of a portion of the original feed gas or original fluid stream 27, which has not been dried by membrane dryer 16 as the sweep for membrane dryer 16 will not allow membrane dryer 16 to produce as dry of a product gas 27a as compared to the use of an equal volume of sweep gas 27b derived from the product gas 27a. That is, the sweep gas 27b derived initially from the compressed gas source 11 will not be as dry as if a portion of the product gas 27a is used, thus the driving force for water vapor to permeate across the membrane dryer 16 is reduced. As the gas on the high-pressure side of the membrane dryer 16 approaches the dew point of the sweep gas 27b on the low-pressure side, water permeation will cease and the membrane dryer 16 will not be able to dry the gas any further.

In view of the above, membrane dryer system 26 will not generally be useful for systems in which extremely dry gas is required. Two exceptions for this are firstly when the high-pressure gas is at very high pressure and secondly when a vacuum source is available to lower the pressure of the sweep gas. In both these cases, the sweep gas 27b can be quite dry, and the membrane system could reach very low dew points. However, since for many systems only a moderate suppression of the dew point is required, using the feed gas as sweep without any added assistance is adequate. This is especially true since in the configuration of the membrane dryer system 26 shown in FIG. 3, in which the sweep gas 27b does not pass first through the high-pressure side of the membrane dryer 16, as in the membrane dryer systems 10 and 25 of FIGS. 1 and 2. This means that for the same sweep ratio and gas production, the flow on the high-pressure (feed) side of the membrane dryer 16 is lower, and thus the residence time is higher. The aforementioned will at least partially offsets the increased moisture in the sweep gas 27b.

As such, for systems, where the compressed gas source cycles and only moderate dew point suppression is required, the configuration of the compressed fluid membrane dryer system 26 of FIG. 3 is ideal as it solves the various problems outlined for the membrane dryer systems 10 and 25 of FIGS. 1 and 2 without the addition of expensive and/or fragile equipment.

The present invention also includes a method of sweep control for a membrane dryer in a pressure cycling system comprising the steps of (1) supplying a fluid 27a at a first pressure from a source of compressed fluid 11 to an accumulator 21 located downstream of a check valve 13 and a membrane dryer 16 and (2) reducing the pressure of a sweep fluid 27b extracted from the source of compressed fluid located upstream of the check valve 13 before directing the sweep fluid 27b through the membrane dryer 16 to thereby remove moisture from the compressed fluid 27a in the membrane dryer 16 without creating backflow through the membrane dryer 16.

The above method can also include the step of (3) simultaneously supplying compressed fluid 27a and 27b to the accumulator 21 and the membrane dryer 16 and (4) directing a flow direction of the sweep fluid 27b through the membrane dryer 16 counter-current to a flow direction of the fluid 27a at a first pressure through the membrane dryer 16.

The present invention further includes a method of sweep control for membrane dryers in pressure cycling systems comprising the steps of (1) directing a primary compressed fluid stream 27a of an original compressed fluid stream 27 through a one-way check valve 13 into a first inlet 17 of a membrane dryer 16, through a body of the membrane dryer 16 and out through a first outlet 18 of the membrane dryer 16 to remove water vapor from the primary compressed fluid stream 27a; and (2) directing a sweep fluid stream 27b of the original compressed fluid stream 27 into a second inlet 19 of the membrane dryer 16, through the body of the membrane dryer 16 and out through a second outlet 20 of the membrane dryer 16 to remove water vapor from the body of the membrane dryer 16; and (3) decompressing the sweep fluid stream before the sweep fluid stream is directed through the membrane dryer 16.

The above method can also include (4) the step of directing a flow direction of the sweep fluid stream 27b through the membrane dryer 16 counter-current to a flow direction of the primary compressed fluid stream 27a through the membrane dryer 16; (5) the step of directing a flow direction of the sweep fluid stream 27b through the membrane dryer 16 co-current to a flow direction of the primary compressed fluid stream 27a through the membrane dryer 16; and (6) the step of directing a flow direction of the sweep fluid stream 27b through the membrane dryer 16 cross-current to a flow direction of the primary compressed fluid stream 27a through the membrane dryer 16.

I claim:

1. A system for supplying a compressed fluid with a reduced moisture content comprising:
a membrane dryer for receiving a compressed fluid and removing moisture therefrom;
a compressed fluid source located upstream of the membrane dryer;
a check valve located upstream of the membrane dryer to prevent backflow therethrough;
an accumulator for receiving the compressed fluid discharged from the membrane dryer; and
an inlet on the membrane dryer for receiving a portion of a compressed fluid from the compressed fluid source wherein the portion of the compressed fluid is diverted from a compressed fluid located upstream of the membrane dryer.

2. The system of claim 1 wherein the membrane dryer includes a selective membrane with a first flow passage for receiving the compressed fluid on a first side of the selective membrane therethrough and a second flow passage for receiving the portion of the compressed fluid on the opposite side of the selective membrane therethrough.

3. The system of claim 2 wherein the membrane dryer includes a first inlet for receiving the compressed fluid into the first flow passage of the membrane dryer and the inlet on the membrane dryer for receiving a portion of a compressed fluid from the compressed fluid source comprises a second inlet for receiving the portion of the compressed fluid into the second flow passage of the membrane dryer.

4. The system of claim 1 wherein the portion of the compressed fluid is diverted from a compressed fluid located upstream of the check valve.

5. The system of claim 1 including a control valve to reduce the pressure of the portion of the compressed fluid before the portion of the compressed fluid enters the inlet of the membrane dryer.

6. The system of claim 1 wherein the source of compressed fluid is a compressor.

7. The system of claim 1 wherein the compressor is the sole source of compressed fluid.

8. The system of claim 1 wherein the check valve located upstream of the membrane dryer to prevent backflow therethrough comprises a one-way check valve.

9. The system of claim 1 wherein the accumulator is in fluid communication with the membrane dryer.

10. The system of claim 1 wherein a flow direction of compressed fluid through the membrane is counter-current to a flow direction of the portion of the compressed fluid through the membrane.

11. The system of claim 1 wherein a flow direction of compressed fluid through the membrane is co-current to a flow direction of the portion of the compressed fluid through the membrane.

12. The system of claim 1 wherein a flow direction of compressed fluid through the membrane is crosscurrent to a flow direction of the portion of the compressed fluid through the membrane.

13. The system of claim 3 wherein the control valve to generate the compressed fluid at a reduced pressure comprises a fixed orifice.

14. A system for supplying a compressed fluid with a reduced moisture content comprising:
a compressed fluid source;
a membrane dryer for receiving a compressed fluid and removing moisture therefrom, the membrane dryer includes a selective membrane with a first flow passage for receiving the compressed fluid on a first side of the selective membrane therethrough and a second flow passage for receiving a compressed fluid at reduced pressure on the opposite side of the selective membrane therethrough;
a check valve located upstream of the membrane dryer to prevent backflow therethrough;
an accumulator for receiving a compressed fluid discharged from the membrane dryer;
a first inlet on the membrane dryer for receiving the compressed fluid into the first flow passage of the membrane dryer;
a second inlet on the membrane dryer for receiving a portion of a compressed fluid from the compressed fluid source into the second flow passage of the membrane dryer wherein the portion of the compressed fluid is diverted from a compressed fluid located upstream of the check valve; and
a control valve to reduce the pressure of the portion of the compressed fluid before the portion of the compressed fluid enters the second inlet of the membrane dryer.

15. The system of claim 14 wherein the check valve located upstream of the membrane dryer to prevent backflow therethrough comprises a one-way check valve.

16. The system of claim 14 including a tee for diverting the portion of the compressed fluid from the compressed fluid located upstream of the check valve to the second inlet on the membrane dryer.

17. The system of claim 14 wherein a flow direction of compressed fluid through the membrane is counter-current to a flow direction of the compressed fluid at a reduced pressure through the membrane.

18. A method of sweep control for a membrane dryer in a pressure cycling system comprising:
supplying a fluid at a first pressure from a source of compressed fluid to an accumulator located downstream of a check valve and a membrane dryer; and
reducing the pressure of a sweep fluid extracted from the source of compressed fluid located upstream of the check valve before directing the sweep fluid through the membrane dryer to thereby remove moisture from the compressed fluid in the membrane dryer without creating backflow through the membrane dryer.

19. The method of claim 18 including the step of simultaneously supplying compressed fluid to the accumulator and the membrane dryer.

20. The method of claim 18 including the step of directing a flow direction of the sweep fluid through the membrane dryer in a counter-current to a flow direction of the fluid at a first pressure through the membrane dryer.
